(19) United States
(12) Patent Application Publication
(10) Pub. No.: US 2017/0238108 A1
(43) Pub. Date: Aug. 17, 2017

(54) INTEGRATED SELF-TEST FOR ELECTRO-MECHANICAL CAPACITIVE SENSORS

(71) Applicant: Robert Bosch GmbH, Stuttgart (DE)

(72) Inventor: John Matthew Muza, Venetia, PA (US)

(73) Assignee: Robert Bosch GmbH, Stuttgart (DE)

(21) Appl. No.: 15/114,314

(22) PCT Filed: Feb. 24, 2015
(86) PCT No.: PCT/US2015/017321

§ 371 Date: Jul. 26, 2016

Related U.S. Application Data
(60) Provisional application No. 61/952,996, filed on Mar. 14, 2014.

(51) Int. Cl. H04R 29/00; H04R 19/04; H04R 19/00

(52) U.S. Cl. CPC H04R 29/004; H04R 19/005; H04R 19/04; H04R 2201/003

(57) ABSTRACT

A self-testing electro-mechanical capacitive sensor system. The system includes an electro-mechanical capacitive sensor and a controller. The controller is configured to receive a signal to activate a test mode, and upon receiving the signal to activate the test mode: (a) apply a bias voltage step to the electro-mechanical capacitive sensor, (b) measure a corresponding deflection of a membrane of the electro-mechanical capacitive sensor for the bias voltage as a function of time, and repeat steps (a) and (b) for a plurality of magnitudes of the bias voltage to determine at least one performance parameter of the electro-mechanical capacitive sensor.

### RELATED APPLICATIONS

This application claims the benefit of U.S. Provisional Application No. 61/952,996, filed Mar. 14, 2014, the entire contents of which are incorporated herein by reference.

### BACKGROUND

The present invention relates to electrical self-testing for capacitive sensors. More particularly, embodiments of the invention relate to integrated all electrical self-testing for Micro-Electro-Mechanical Systems (MEMS) microphones.

Today the testing of MEMS microphones comes with various challenges and associated costs in time and money. For example, ambient acoustic noise and vibration as seen by the device under test must be reduced. Production test floors commonly have very high acoustic noise levels from various sources such as motors, HVAC systems, people, and other industrial facilities. This requires expensive and uncommon isolation techniques, and possibly even separate acoustic testing rooms and chambers. Currently, custom test solutions are required with acoustic speakers and microphones for proper testing. These reference speakers and microphones must be calibrated and maintained to ensure consistent test quality. The general acoustic requirements of the current test methodology limit the parallelization of devices under test, which consequently increases the test cost. The limited amount of exercise that the mechanical system experiences during this type of testing also leads to concerns about quality because the microphone is usually tested at only one functional bias point rather than throughout its mechanical range. Furthermore, there is limited access to determining the MEMS characteristics, such as the mechanical resonance frequency, without using specialized test chips, specialized test setups, such as vacuum chamber systems, or both.

Therefore, embodiments of the invention provide systems and methods for integrated all electrical self-testing for Micro-Electro-Mechanical Systems (MEMS) microphones.

### SUMMARY

In one embodiment, the invention provides a system for self-testing an electro-mechanical capacitive sensor. The system includes an electro-mechanical capacitive sensor and a controller. The controller is configured to receive a signal to activate a test mode, and upon receiving the signal to activate the test mode: (a) apply a bias voltage to the electro-mechanical capacitive sensor, (b) measure a corresponding deflection of a membrane of the electro-mechanical capacitive sensor for the bias voltage as a function of time, and repeat steps (a) and (b) for a plurality of magnitudes of the bias voltage to determine at least one performance parameter of the electro-mechanical capacitive sensor. The performance parameter determined may be a sensitivity as a function of an applied bias voltage, a pull-in voltage, a −3 dB frequency response point, a resonant frequency, a resistive damping/quality factor component, a capacitance, or any combination of the foregoing.

In some embodiments, the capacitance includes a parasitic capacitance.

In other embodiments, the system also includes a preamplifier. In such embodiments, the capacitance can be determined by measuring a slew rate of a unity gain output of a pre-amplifier.

In other embodiments, the capacitance can be determined by applying a high-frequency AC stimulus to the electro-mechanical capacitive sensor, and measuring a current output of the electro-mechanical capacitive sensor.

In some embodiments, the electro-mechanical capacitive sensor and controller are combined in a single package.

In some embodiments, the electro-mechanical capacitive sensor is a MEMS microphone.

In some embodiments, step (b) of the test mode is performed by a second processor.

In another embodiment, the invention provides a method for self-testing an electro-mechanical capacitive sensor system including a controller. The method includes (a) applying, by the controller, a bias voltage to the electro-mechanical capacitive sensor, (b) measuring, by the controller, a corresponding deflection of a membrane of the electro-mechanical capacitive sensor for the bias voltage as a function of time, and repeating steps (a) and (b) for a plurality of magnitudes of the bias voltage to determine at least one performance parameter of the electro-mechanical capacitive sensor.

Other aspects of the invention will become apparent by consideration of the detailed description and accompanying drawings.

### BRIEF DESCRIPTION OF THE DRAWINGS

FIG. 1 is a block diagram of an electro-mechanical capacitive sensor integrated circuit.

FIG. 2 is a plot of common capacitive sensor electro-mechanical relationship.

FIG. 3 is a plot of an applied bias voltage stepped over time.

FIG. 4 is an example plot of a multi-order transient step response for a capacitive sensor.

FIG. 5 is a block diagram of a method used by the integrated circuit of FIG. 1 to perform electrical self-tests.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “control units” and “controllers” described in the specification can include one or more processors, one or more memory modules including non-transitory computer-readable medium, one or more input/output interfaces, and various connections (e.g., a system bus) connecting the components.

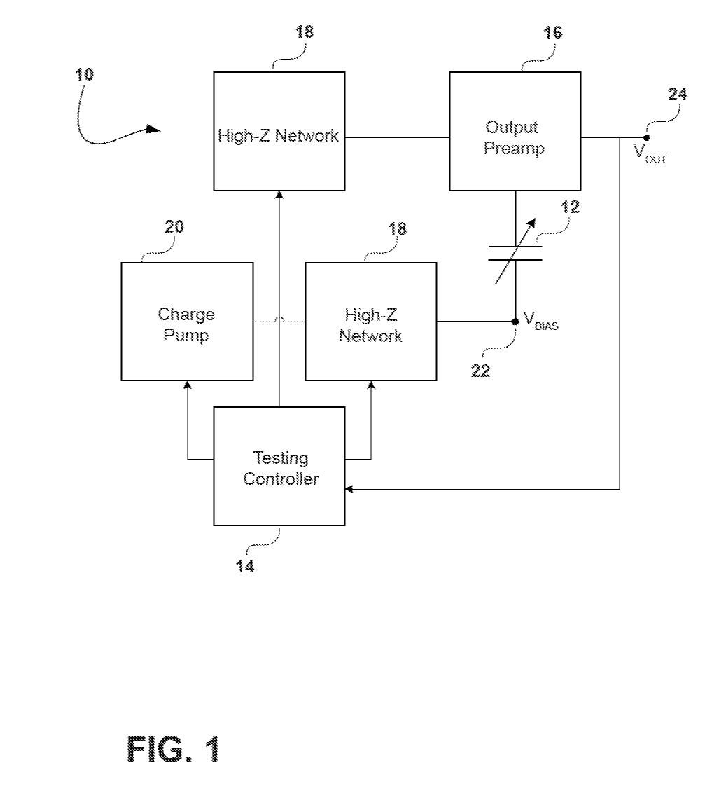

FIG. 1 illustrates an electro-mechanical capacitive sensor integrated circuit (MCSIC) 10. The MCSIC 10 includes a MEMS sensor 12, a testing controller 14, an output preamplifier 16, two high-impedance networks 18, a charge pump 20, a bias voltage node 22, and an output voltage node 24. The testing controller 14 is connected to the high-impedance networks 18, the charge pump 20, and the output voltage node 24. The testing controller 14 is also configurable to send and receive signals and data to electronics outside the MCSIC 10. The high-impedance networks 18 and the charge pump 20 apply voltage bias to the MEMS sensor 12. The high-impedance networks 18 are capable of entering low-impedance state, to protect MEMS sensor 12 from a change in bias voltage. The charge pump 20 is configurable to provide a range of voltages to bias voltage node 22. The testing controller 14 is configurable to signal the charge pump 20 to apply a specified bias voltage (V_{BIAS}) to the MEMS sensor 12. The testing controller 14 is also configurable to signal the charge pump 20 to provide a self-generated electrical step (ΔV) in V_{BIAS} to the MEMS sensor 12 at bias voltage node 22 during a force mode. The testing controller 14 is configurable to signal the high-impedance networks 18 to enter a low-impedance state as ΔV is being applied. The testing controller 14 is also configurable to enter a sense mode very soon (1-3 μs) after ΔV has been applied, and signal the high-impedance networks 18 to enter a high-impedance state during sense mode. The testing controller 14 is also configurable to measure the response of the MEMS sensor 12 the application of a ΔV as an output voltage (V_{OUT}) at the output voltage node 24. While in sense mode, the V_{OUT} of the MEMS output preamplifier 16, produced as a result of the testing inputs (steps of V_{BIAS}) to the MEMS sensor 12, may be measured at output voltage node 24, either by the testing controller 14, or by test equipment external to the MCSIC 10.

In some embodiments, the testing controller 14 includes a plurality of electrical and electronic components that provide power, operational control, and protection to the components and modules within the testing controller 14. The testing controller 14 includes, among other things, a processing unit (e.g., a microprocessor or another suitable programmable device), a memory, and an input/output interface. The processing unit, the memory, and the input/output interface, as well as the other various modules are connected by one or more control or data buses. In some embodiments, the testing controller 14 is implemented partially or entirely on a semiconductor chip (e.g., a field-programmable gate array).

The memory of testing controller 14 includes a program storage area and a data storage area. The program storage area and the data storage area can include combinations of different types of memory, such as read-only memory (“ROM”), random access memory (“RAM”) (e.g., dynamic RAM (“DRAM”), synchronous DRAM (“SDRAM”), etc.), electrically erasable programmable read-only memory, or other suitable electronic memory devices. The processing unit is connected to the memory and executes software instructions that are stored in a RAM of the memory (e.g., during execution), a ROM of the memory (e.g., on a generally permanent basis), or another non-transitory computer readable medium. Software included for the processes and methods for electrical self-testing of MEMS sensor 12 can be stored in the memory of the testing controller 14. The software can include firmware, one or more applications, program data, filters, rules, one or more program modules, and other executable instructions. For example, the testing controller 14 effectively stores information relating to the electrical and mechanical characteristics of the MEMS sensor 12. The processing unit is configured to retrieve from memory and execute, among other things, instructions related to the testing processes and methods described herein. In other constructions, the testing controller 14 includes additional, fewer, or different components.

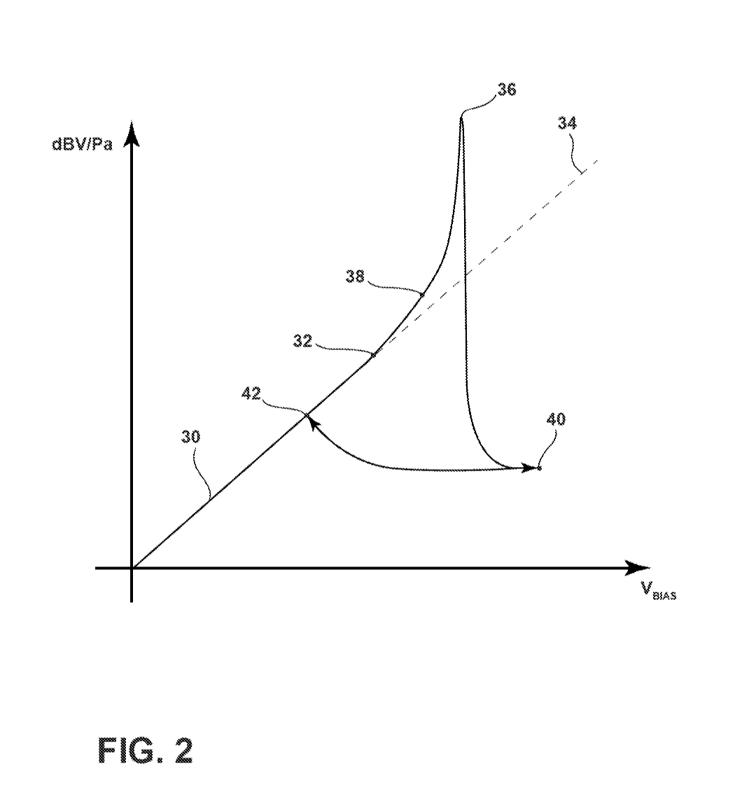

FIG. 2 is a plot of the acoustic-mechanical sensitivity of the MEMs sensor 12 (in dBV/Pa) as a function of an applied V_{BIAS}, represented by line 30. As V_{BIAS} increases, the sensitivity of the MEMS sensor 12 increases proportionally to V_{BIAS}. At about point 32, the relationship between sensitivity and V_{BIAS} changes. Past point 32, line 30 departs from its expected path 34, and the sensitivity increases exponentially until the pull-in voltage, V_{PULL}_{_}_{IN}, is reached at point 36. The pull-in voltage is the voltage at which the movable membrane of MEMS sensor 12 is pulled all the way in and makes contact with the backplate of the sensor. At V_{PULL}_{_}_{IN}, MEMS sensor 12 will not function properly. Because the actual V_{PULL}_{_}_{IN} of each sensor is not precisely known, a factory-specified operating V_{BIAS} for the MEMS sensor 12 is determined based on the expected V_{PULL}_{_}_{IN}, which is known from the particular sensor's factory specifications. Point 38 on line 30 represents an example typical factory-specified operating V_{BIAS} for a MEMS sensor 12 characterized by line 30, which, to account for variances in V_{PULL}_{_}_{IN} between different instances of the same model sensor, is commonly set at about 80% of V_{PULL}_{_}_{IN}. This is done to avoid operating the MEMS sensor too close to its actual V_{PULL}_{_}_{IN}.

As shown in FIG. 2, stepping through a range of V_{BIAS} can provide a full picture of the mechanical stability of the MEMS sensor 12 through V_{PULL}_{_}_{IN} and the following mechanical hysteresis present in the reverse voltage direction. The transduction mechanism works as the common conservation of charge principle, ΔC/(C0÷CP). The range of V_{BIAS} is determined by the expected V_{PULL}_{_}_{IN}. As shown in FIG. 2, V_{BIAS} is swept from near zero to a point 40 sufficiently past V_{PULL}_{_}_{IN} to fully characterize the MEMS sensor 12, and back to a second point 42, where the response is again proportional. The hysteresis of a MEMS sensor is very design-dependent. The greater the bias voltage of a sensor, the less total hysteresis there is.

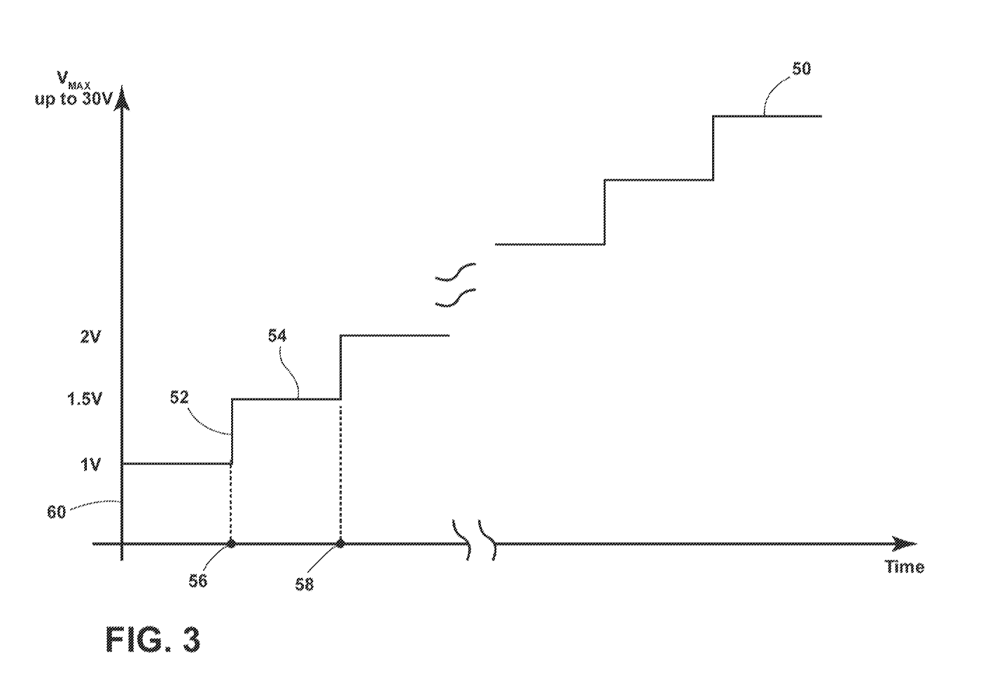

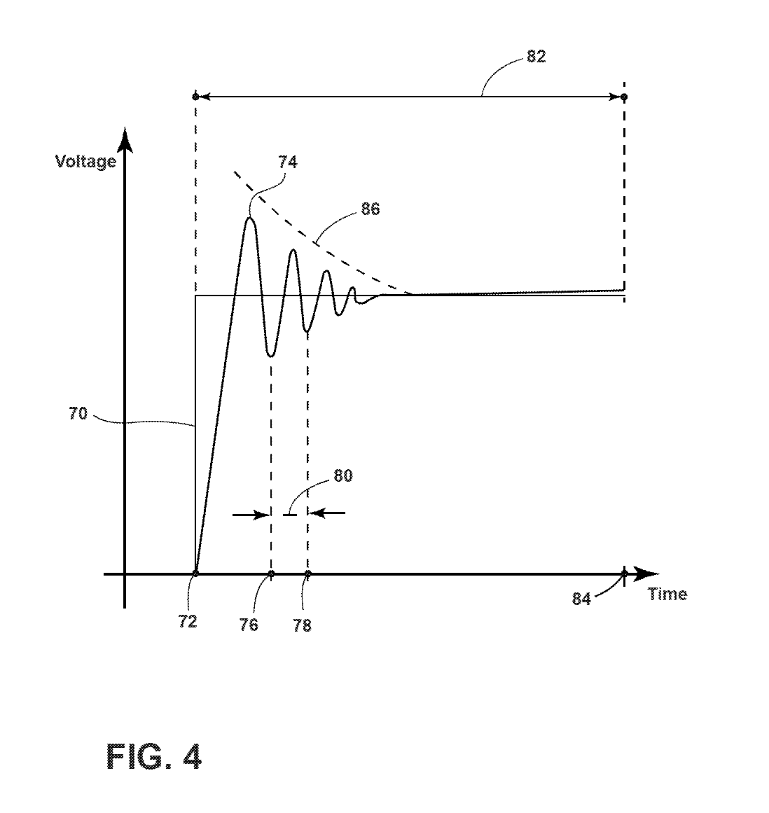

FIG. 3 is a plot of the step response input to the MEMS sensor 12 generated by the testing controller 14 and the charge pump 20. The line 50 shows the bias voltage applied by the charge pump 20, stepped up over time. The steps are controlled by testing controller 14. As shown in FIG. 3, line 50 shows step sizes of 0.0 volt over a range of 30 volts. Edge 52 is representative of the vertical portions of line 50, and shows the application of a 0.0 volt ΔV at a point in time 56. Segment 54 is representative of the horizontal portions of line 50, and shows the application of a bias voltage from 1-3 μs after point in time 56 to second point in time 58, approximately thirty-two milliseconds later. Edge 52 lasts 1-3 μs to provide a voltage step that happens more quickly than the acoustic-mechanical response, so the response can be measured, as described below in relation to FIG. 4.

It should be noted that while this combination of step size and range combination may be sufficient to electrically test some MEMS sensors, it may not work for all MEMS sensors, and other combinations are possible. The step size of V_{BIAS} used for testing must be large enough to drown out external noise, but small enough to avoid saturating the channel of the MEMS sensor. If the step size is too small, it will not produce a usable output, but if it is too large, it will drown out the usable output. The minimum voltage for the range of V_{BIAS} used for testing is near, but above, the minimum voltage required to keep all the components of the MCSIC 10 functioning. The maximum voltage for the range is determined by the MEMS sensor design, and is sufficiently higher than the expected V_{PULL}_{_}_{IN} for the MEMS sensor, such that the range of V_{BIAS} will capture the full curve for the MEMS sensor, as shown in FIG. 2. The total number of steps that will be applied is equal to the range divided by the step size. For example, line 50 would apply fifty-eight steps of V_{BIAS}.

The initial step to IV at point 60 on line 50 is not included in the range. That initial transition is known as the RESET phase. During the RESET phase, it is possible to determine electrically other useful parameters that otherwise would not be accessible by acoustic testing. The other parameters that can be measured include the oscillator (clock) frequency, the reference voltage, the reference current (I_{REF}), the Power Supply Rejection Ratio (PSRR), the Common Mode Rejection Ratio (CMRR), the Charge pump output voltage, the amplifier gain, and the amplifier bandwidth. The I_{REF} is used during subsequent steps to measure the capacitance of the MEMS sensor 12.

FIG. 4 illustrates how characteristics of the MEMS sensor 12 can be directly measured using a step response as illustrated in FIG. 3. The electrical force is used in lieu of an acoustic pressure to reduce cost and complexity of the test operation. When a step, represented by line 70, is initially applied as a ΔV during force mode at point 72, the membrane in the MEMS sensor 12 moves from its previous position, and “settles” into place. The corresponding deflection of the MEMS sensor 12 membrane as a function of time can then be measured during sense mode at output voltage node 24. The final settling of the MEMS motion is dominated by the air pressure equalizing on both sides of the movable membrane due to the acoustic leak across the membrane. When plotted, the output caused by the ringing produces a damped sine wave 74, which reveals the high frequency settling characteristics in response to the high frequency electrical step input. Because the acoustic and mechanical characteristics of the MEMS sensor 12 determine its settling characteristics, analysis of the damped sine wave 74 can in turn reveal acoustic and mechanical characteristics of the MEMS sensor 12.

The acoustic-mechanical system resonance frequency can be directly measured using the following equation:

Period=1/F_{RES}

where Period is an individual period of wave 74, for example between points 76 and 78; and F_{RES} is the resonance frequency.

The −3 dB frequency response point for the MEMS sensor 12 can be determined from the total time of the voltage settling, 82, as measured between points 72 and 84. A direct measure of the resistive damping/quality factor component of the MEMS sensor 12 can also be made by measuring the decay rate 86 of the ringing.

The total capacitance (C₀+CP) of the MEMS sensor 12 as a function of DC applied bias voltage can be electrically measured using a slew rate measurement of the unity gain preamplifier output, which represents the MEMS sense node. This can be accomplished using the following equation:

(C₀+C_{P})=I_{REF}/SR

where C₀ is the self-capacitance of the MEMS sensor 12, C_{P} is the parasitic capacitance of the MEMS sensor 12, SR is the slew rate, and I_{REF} is a reference current, which was measured during the RESET phase. In other embodiments of the invention, the testing controller 14 is configurable to apply a high frequency AC stimulus and measure a subsequent current to determine capacitance.

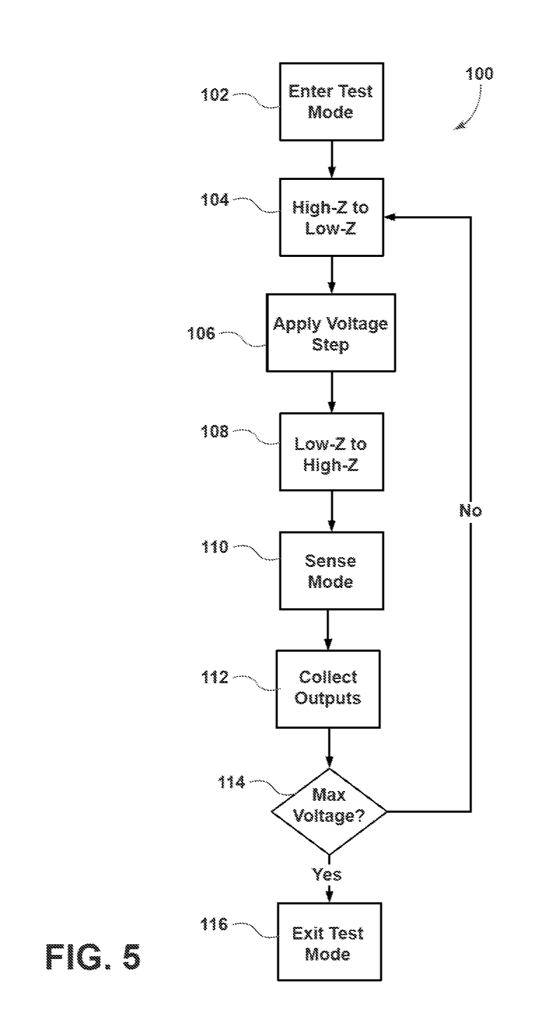

FIG. 5 is a block diagram illustrating a method 100 used by MCSIC 10 to self-test the MEMS sensor 12. The testing controller 14 receives a signal to enter a self-test mode, and enters test mode (at block 102). The signal may be a specified voltage level applied to a specific pin or input of the testing controller 14. When in test mode, MCSIC 10 steps through a range of bias voltages, as illustrated in FIG. 3, and reads the results of each step as shown in FIG. 4, to determine curve for the MEMS sensor, as illustrated in FIG. 2. Each voltage step consists of a force mode, where the new bias voltage is applied, and a sense mode, where the output produced by the application of the bias voltage, or force, is read. In force mode, the testing controller 14 signals the high-impedance networks 18 to enter a low-impedance state (at block 104). The testing controller then signals the charge pump 20 to apply the specified bias voltage to the MEMS sensor 12 at bias voltage node 22 (at block 106). After 1-3 μs, the testing controller 14 signals the high-impedance networks 18 to enter a high-impedance state (at block 108), and changes to sense mode (at block 110). During sense mode, which lasts approximately thirty-two milliseconds(based on the MEMS sensor −3 dB frequency), the testing controller 14 captures the motion of the membrane of the MEMS sensor 12 in response to the applied voltage force by collecting the analog output data at output voltage node 24 (at block 112), and determines the electrical and mechanical characteristics of the MEMS sensor 12. Force and sense modes are repeated for a range of DC bias voltages across the MEMS sensor 12 to fully characterize the acoustic-mechanical system. The magnitude of the steps and the range over which the bias voltage is stepped are determined based on the factory specifications of the MEMS sensor 12. When the maximum voltage has been applied (at block 114), the testing controller 14 exits test mode (at block 116), and the MCSIC 10 returns to a normal operational mode.

Method 100 can be used to perform different types of tests, e.g., a probe test and a final test. The probe and final tests operate similarly, as described herein. A probe test is performed by running method 100 over the full range of bias voltages to achieve a full test and characterization of MEMS sensor 12 is known as a probe test. Probe testing can be performed at the wafer level before the MCSIC 10 is packaged.

Final test mode operates using method 100 over an abbreviated range of bias voltages, for example a range three steps around the specified operating bias voltage of the MEMS sensor 12, to reduce the time and cost of testing. This final test mode would not be able to generate the full curve of FIG. 2, but it would be able to provide measurements of sensitivity, capacitance, resonance frequency, −3 dB frequency, and resistance damping/quality factor. The final test mode is useful in production, where the testing controller 14, or outside testing equipment, could then compare the values of those characteristics with the factory specifications to pass or fail the MEMS sensor 12. Final testing is typically performed after MCSIC 10 is packaged.

Both probe and final tests can be utilized in many ways, and at various times including: a test probe external to the chip, a one-chip integrated sensor with self-testing, during final production testing, at every application of the power supply to the circuits, by the end-user system, and by the sensor itself to periodically check status and adjust calibration settings.

It should be noted that a MEMS sensor equipped with embodiments of the invention can be self-aware and configurable. Using embodiments of the invention, the end user can manipulate the MEMS microphone, or the system of which it is a part, for optimized performance. For example, an end user can more optimally set the operating bias voltage of a given MEMS sensor to increase sensitivity. As noted above, a typical factory-specified operating V_{BIAS} for a MEMS sensor is conservatively set at about 80% of V_{PULL}_{_}_{IN}. However, a self-aware MEMS microphone using the systems and methods described herein could know its MEMS sensor's V_{PULL}_{_}_{IN} more precisely. This would allow the end user of such a MEMS microphone, or the microphone itself, to set the operating V_{BIAS} closer to V_{PULL}_{_}_{IN}, thereby increasing the stable sensitivity of the MEMS sensor beyond what could be achieved by relying on the general factory specification for that model of MEMS sensor.

Using embodiments of the invention, the end user, or the microphone itself, can also manipulate the MEMS microphone, or the system of which it is a part to account for changes in environment, use case, or quality, degradation. For example, a system could: monitor and adjust the −3 dB frequency in response to different wind conditions; monitor and adjust the +3 dB frequency for improved signal bandwidth; monitor the quality of the acoustic gasketing (sealing) by the end customer, and take corrective actions in the microphone based on characteristics of the sealing; and monitor the MEMS characteristics as they change over time due to aging, adjusting the bias voltage to maintain optimum performance and quality levels.

Thus, the invention provides, among other things, an integrated all-electrical self-test for electro-mechanical capacitive sensors. Various features and advantages of the invention are set forth in the following claims.

What is claimed is:

1. A self-testing electro-mechanical capacitive sensor system, the system comprising:
an electro-mechanical capacitive sensor;
a controller configured to
receive a signal to activate a test mode, and upon receiving the signal to activate the test mode wherein
(a) a bias voltage step is applied to the electro-mechanical capacitive sensor,
(b) a corresponding deflection of a membrane of the electro-mechanical capacitive sensor is measured for the bias voltage step as a function of time, and
steps (a) and (b) are repeated for a plurality of magnitudes of the bias voltage to determine at least one performance parameter of the electro-mechanical capacitive sensor.

2. The system of claim 1, wherein the at least one performance parameter is at least one of a group consisting of
a sensitivity as a function of an applied bias voltage,
a pull-in voltage,
a −3 dB frequency response point,
a resonant frequency,
a resistive damping factor component, and
a capacitance.

3. The system of claim 2, wherein the capacitance includes a parasitic capacitance.

4. The system of claim 2, further comprising a preamplifier, wherein determining the capacitance includes measuring a slew rate of a unity gain output of the preamplifier.

5. The system of claim 2, where the test mode further includes
applying a high-frequency AC stimulus to the electro-mechanical capacitive sensor, and
measuring a current output of the electro-mechanical capacitive sensor, and
determining the capacitance of the electro-mechanical capacitive sensor.

6. The system of claim 1, wherein the electro-mechanical capacitive sensor and controller are combined in a single package.

7. The system of claim 1, wherein the electro-mechanical capacitive sensor is a MEMS microphone.

8. The system of claim 1, further comprising a second controller, wherein step (b) is performed by the second controller.

9. A method for self-testing an electro-mechanical capacitive sensor system including a controller, the method comprising:
(a) applying, by the controller, a bias voltage step to the electro-mechanical capacitive sensor,
(b) measuring, by the controller, a corresponding deflection of a membrane of the electro-mechanical capacitive sensor for the bias voltage step as a function of time,
repeating steps (a) and (b) for a plurality of magnitudes of the bias voltage to determine at least one performance parameter of the electro-mechanical capacitive sensor.

10. The method of claim 9, wherein the at least one performance parameter is at least one of a group consisting of
a sensitivity as a function of an applied bias voltage,
a pull-in voltage,
a −3 dB frequency response point,
a resonant frequency,
a resistive damping factor component, and
a capacitance.

11. The method of claim 10, wherein the capacitance includes a parasitic capacitance.

12. The method of claim 10, wherein determining the capacitance includes measuring, by the controller, a slew rate of a unity gain output of a preamplifier.

13. The method of claim 10, further comprising
applying, by the controller, a high-frequency AC stimulus to the electro-mechanical capacitive sensor, and
measuring, by the controller, a current output of the electro-mechanical capacitive sensor, and
determining, by the controller, the capacitance of the electro-mechanical capacitive sensor.

14. The method of claim 9, wherein the electro-mechanical capacitive sensor is a MEMs microphone.

15. The method of claim 14, wherein step (b) is performed by a second controller.
